(19) United States
(12) Patent Application Publication
(10) Pub. No.: US 2020/0182902 A1
(43) Pub. Date: Jun. 11, 2020

(54) CHARGE OUTPUT ELEMENT AND ANNULAR SHEAR-TYPE PIEZOELECTRIC ACCELEROMETER

(71) Applicant: FATRI UNITED TESTING & CONTROL (QUANZHOU) TECHNOLOGIES CO., LTD., Fujian (CN)

(72) Inventors: Yongzhong NIE, Xiamen City, Fujian (CN); Chuan NIE, Xiamen City, Fujian (CN)

(73) Assignee: FATRI UNITED TESTING & CONTROL (QUANZHOU) TECHNOLOGIES CO., LTD., Fujian (CN)

(21) Appl. No.: 16/614,458

(22) PCT Filed: May 25, 2018
(86) PCT No.: PCT/CN2018/088449

§ 371 Date: Nov. 18, 2019

(30) Foreign Application Priority Data
Jun. 7, 2017 (CN) 201710423718.5

(51) Int. Cl. G01P 15/09

(52) U.S. Cl. CPC G01P 15/0915

(57) ABSTRACT

Disclosed is a charge output element, comprising: a base, comprising a supporting part and a connecting part arranged on the supporting part, the connecting part being provided with a mounting hole; a support, sheathed on the connecting part and arranged a clearance away from the connecting part, the support being connected to the supporting part; a piezoelectric element, connected to the support in a sheathed manner; and a mass block, connected to the piezoelectric element in a sheathed manner and hanging in the air above the supporting part. Further disclosed is an annular shear-type piezoelectric accelerometer. The charge output element and the annular shear-type piezoelectric accelerometer can prevent the impacts of a connecting member on the piezoelectric element, thereby ensuring the stability of the frequency response and the transverse sensitivity of the annular shear-type piezoelectric accelerometer and thus ensuring the accuracy of a detection result.

### CROSS-REFERENCE TO RELATED APPLICATION

The application is a National Stage of International Application No. PCT/CN2018/088449 filed on May 25, 2018, which claims priority to Chinese Patent Application No. 201710423718.5 filed on Jun. 7, 2017 and entitled “CHARGE OUTPUT ELEMENT AND ANNULAR SHEAR-TYPE PIEZOELECTRIC ACCELEROMETER”, both of which are incorporated herein by reference in their entireties.

### TECHNICAL FIELD

The disclosure relates to the technical field of piezoelectric accelerometer, and in particular to a charge output element and an annular shear-type piezoelectric accelerometer.

### BACKGROUND

A piezoelectric accelerometer, known as piezoelectric acceleration sensor, belongs to an inertial sensor. The piezoelectric accelerometer is a sensor in which the force applied to the piezoelectric element by the mass block will change by means of the piezoelectric effect of the piezoelectric element as the accelerometer vibrates. When the detected vibration frequency is much lower than the natural frequency of the accelerometer, the change in force is proportional to the detected acceleration.

The piezoelectric accelerometer mainly has following structures such as a centrally mounted compression type, a flip-chip center-compressed type, and an annular shear-type. The annular shear-type piezoelectric accelerometer has a simple structure, an extremely small size, a high resonance frequency, and a broader application.

The annular shear-type piezoelectric accelerometer in the prior art generates an electrical signal proportional to the acceleration value by using the shear deformation of the piezoelectric element. The annular shear-type piezoelectric accelerometer mainly includes a charge output element and a circuit board, and the charge output element includes a base, a piezoelectric element and a mass block. When the annular shear-type piezoelectric accelerometer is in use, a connecting member needs to be fitted into the charge output element. However, the fitting of the connecting member may cause a stress to be generated on the base and to be transmitted to the piezoelectric element, resulting in the unstable frequency response and transverse sensitivity when the annular shear-type piezoelectric accelerometer is in use, and thereby affecting the detection result.

### SUMMARY

Embodiments of the disclosure provide a charge output element and an annular shear-type piezoelectric accelerometer, which can prevent the impacts of a connecting member on the piezoelectric element, ensure the frequency response and the stability of the transverse sensitivity of the annular shear-type piezoelectric accelerometer, and further ensure the accuracy of the detection result.

An embodiment of the disclosure provides a charge output element including: a base, including a supporting part and a connecting part arranged on the supporting part, the connecting part being provided with a mounting hole; a support, sheathed on the connecting part and arranged with a clearance away from the connecting part, the support being connected to the supporting part; a piezoelectric element, connected to the support in a sheathed manner; and a mass block, connected to the piezoelectric element in a sheathed manner and suspended above the supporting part.

Another aspect of the disclosure provides an annular shear-type piezoelectric accelerometer, including the above-mentioned charge output element and a circuit board. The circuit board is arranged at a predetermined distance from the piezoelectric element and the mass block arranged, and the piezoelectric element is electrically connected to the circuit board to transmit an electrical signal of the piezoelectric element to the circuit board.

The charge output element and the annular shear-type piezoelectric accelerometer according to the embodiments of the disclosure include the base, the support, the piezoelectric element, and the mass block. When the connecting member is fitted into the mounting hole in the connecting part of the base in use, since the piezoelectric element is connected to the support in a sheathed manner and the support is sheathed on the connecting part of the base and arranged with a clearance away from the connecting part, even if a stress is caused to be generated on the base due to the fitting of the connecting member into the mounting hole, the stress will not be transmitted to the piezoelectric element. Therefore, it is possible to prevent the impacts of the connecting member on the piezoelectric element, to ensure the frequency response and the stability of the transverse sensitivity of the annular shear-type piezoelectric accelerometer, and to ensure the accuracy of the detection result.

### BRIEF DESCRIPTION OF THE DRAWINGS

Features, advantages, and technical effects of the exemplary embodiments of the disclosure will be described below with reference to the drawings.

FIG. 1 is a schematic perspective structural view of a charge output element according to an embodiment of the disclosure;

FIG. 2 is a schematic cross-sectional structural view of a charge output element according to an embodiment of the disclosure;

FIG. 3 is a schematic structural view of a base according to an embodiment of the disclosure;

FIG. 4 is a schematic structural view of a support according to an embodiment of the disclosure;

FIG. 5 is a schematic structural view of a piezoelectric element according to an embodiment of the disclosure;

FIG. 6 is a schematic structural view of a mass block according to an embodiment of the disclosure;

FIG. 7 is a schematic perspective structural view of an annular shear-type piezoelectric accelerometer according to an embodiment of the disclosure; and

FIG. 8 is a schematic cross-sectional structural view showing an annular shear-type piezoelectric accelerometer according to an embodiment of the disclosure, wherein:

| | | | |
|---|---|---|---|
| 1 | charge output element; | 10 | base; |
| 11 | supporting part; | 12 | connecting part; |
| 13 | mounting hole; | 14 | positioning groove; |
| 20 | support; | 21 | inner annular surface; |
| 22 | outer annular surface; | 23 | support flange; |
| 24 | positioning block; | 30 | piezoelectric element; |
| 31 | inner annular surface; | 32 | outer annular surface; |
| 40 | mass block; | 41 | inner annular surface; |
| 42 | outer annular surface; | 2 | circuit board; |
| 3 | casing; | 4 | partition plate; |
| 5 | connecting member; | 6 | sealing cover. |

### DETAILED DESCRIPTION

Features and exemplary embodiments in various aspects of the disclosure are described in detail below. In the following detailed description, numerous specific details are set forth to provide comprehensive understanding of the disclosure. However, it will be apparent to the skilled in the art that the disclosure may be practiced without some of the specific details. The following description of the embodiments is merely to provide a better understanding of the disclosure. In the drawings and the following description, at least some of the known structures and techniques are not shown, to prevent unnecessary obscure of the disclosure. For clarity, the dimension of some of the structures may be enlarged. Furthermore, features, structures, or characteristics described hereinafter may be combined in any suitable manner in one or more embodiments.

The orientation terms appearing in the following description refer to the directions shown in the drawings, and are not intended to limit the specific structure of the embodiment of the disclosure. In the description of the disclosure, it should also be noted that, unless otherwise explicitly stated and defined, the terms “mount” or “connect” shall be understood broadly, for example, they may be fixed connection or detachable connection or integral connection; alternatively, they may be direct connection or indirect connection. The specific meaning of the above terms in the disclosure may be understood by the skilled in the art based on the specific situation.

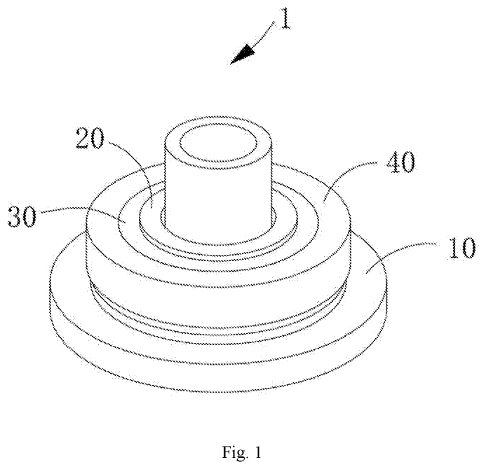

For a better understanding of the disclosure, a charge output element according to embodiments of the disclosure will be described in detail below with reference to FIG. 1 to FIG. 6.

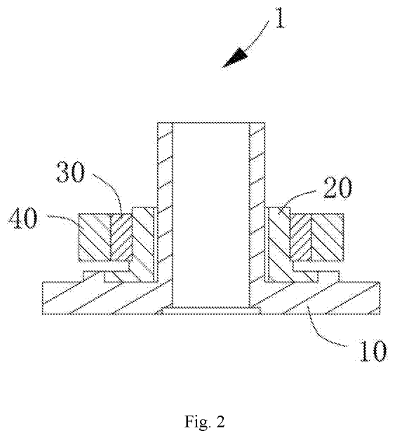

As shown in FIG. 1 to FIG. 4, an embodiment of the disclosure provides a charge output element 1, including a base 10, a support 20, a piezoelectric element 30, and a mass block 40. The base 10 includes a supporting part 11 and a connecting part 12 arranged on the supporting part 11. The connecting part 12 is provided with a mounting hole 13. The support 20 is sheathed on the connecting part 12 and arranged with a clearance away from the connecting part 12. The support 20 is connected to the supporting part 11. The piezoelectric element 30 is connected to the support 20 in a sheathed manner. The mass block 40 is connected to the piezoelectric element 30 in a sheathed manner and suspended above the supporting part 11. The term “above” as described herein refers to the upwards shown in FIG. 2. The expression “suspended” as described herein may be understood as a certain clearance being left between the mass block 40 and the supporting part 11.

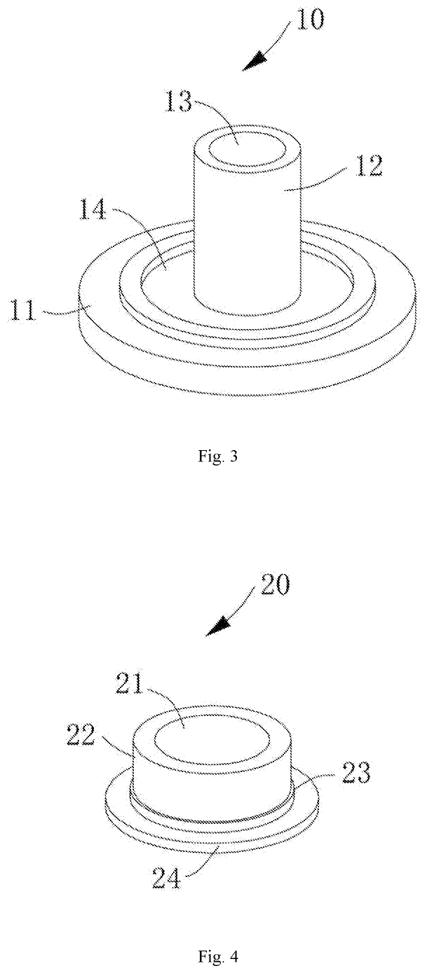

Specifically, as shown in FIG. 3, in the present embodiment, the connecting part 12 has a columnar structure. The mounting hole 13 is arranged along an axial direction of the connecting part 12 and penetrates the connecting part 12. The supporting part 11 has a disc-like structure arranged around the connecting part 12 and is located at one end of the connecting part 12. That is, the mounting hole 13 also penetrates the supporting part 11.

As shown in FIG. 2 and FIG. 4, the support 20 is an annular structural body arranged around the connecting part 12 and is made of a titanium alloy material. The support 20 includes an inner annular surface 21 and an outer annular surface 22 that are opposite. In the present embodiment, the support 20 is an annular structural body that is continuously arranged around the connecting part 12, the inner annular surface 21 thereof is an inner wall surface of the annular structural body, and the outer annular surface 22 thereof is an outer wall surface of the annular structural body. Each of the outer wall surface of the connecting part 12 and the inner annular surface 21 has a circular cross section, and the cross section of the inner annular surface 21 has a diameter larger than that of the cross section of the outer wall surface of the connecting part 12, so that the clearance is left between the inner annular surface 21 of the support 20 and the outer wall surface of the connecting part 12 when the support 20 is sheathed on the connecting part 12.

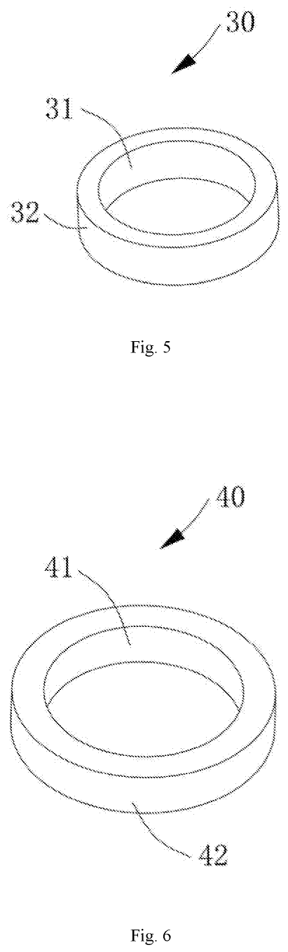

As shown in FIG. 2 and FIG. 5, the piezoelectric element 30 is an annular structural body and is made of piezoelectric ceramic. The piezoelectric element 30 includes an inner annular surface 31 and an outer annular surface 32 that are opposite. Each of the inner annular surface 31 and the outer annular surface 32 of the piezoelectric element 30 is plated with a conductive layer. The conductive layer is made of gold or other material capable of conducting electricity. The inner annular surface 31 of the piezoelectric element 30 is connected to the outer annular surface 22 of the support 20 in a sheathed manner.

As shown in FIG. 2 and FIG. 6, the mass block 40 is an annular structural body and is made of a tungsten alloy material. The mass block 40 includes an inner annular surface 41 and an outer annular surface 42 that are opposite. The inner annular surface 41 of the mass block 40 is connected to the outer annular surface 32 of the piezoelectric layer element 30 in a sheathed manner.

The expression “connected in a sheathed manner” means that one part is sheathed on and connected to the other part. In the present embodiment, the piezoelectric element 30 is sheathed on and connected to the support 20, and the mass block 40 is sheathed on and connected to the piezoelectric element 30. In the present embodiment, in order to ensure the rigidity and stability of the structure of the charge output element 1, the piezoelectric element 30 is bonded and fixed to the support 20 by the adhesive, and the mass block 40 is bonded and fixed to the piezoelectric element 30 by the adhesive. In order to facilitate the positioning and bonding of the piezoelectric element 30, the outer annular surface 22 of the support 20 is provided with a support flange 23 along its circumferential direction. The support flange 23 has a height higher than a height of the supporting part 11. The piezoelectric element 30 abuts against the support flange 23. It should be noted that the height direction herein is along the axial direction of the connecting part 12.

Thus, in use of the charge output element 1 according to the embodiment of the disclosure, when a connecting member is fitted into the mounting hole 13 of the connecting part 12, since the piezoelectric element 30 is connected to the support 20 in a sheathed manner and the support 20 is sheathed on the connecting part 12 and arranged with a clearance away from the connecting part 12, even if a stress is caused to be generated on the base 10 due to the fitting of the connecting member into the mounting hole 13, the stress will not be transmitted to the piezoelectric element 30. Therefore, it is possible to prevent the impacts of the connecting member on the piezoelectric element 30, to ensure the frequency response and the stability of the transverse sensitivity of the annular shear-type piezoelectric accelerometer, and to ensure the accuracy of the detection result.

It is to be understood that the support 20 is not limited to the annular structural body that is continuously arranged around the connecting part 12. In some alternative embodiments, the support 20 may also be an annular structural body that is formed by being enclosed by two or more arc-shaped single structures arranged around the connecting part 12. In such case, the inner annular surface 21 of the support 20 is formed by being collectively enclosed by the inner wall surfaces of the two or more arc-shaped single structures, and the outer annular surface 22 of the support 20 is formed by being collectively enclosed by the outer wall surfaces of the two or more arc-shaped single structures. By means of the above structure of the support 20, the use requirements of the charge output element 1 may also be ensured. Furthermore, the piezoelectric element 30 is not limited to being made of piezoelectric ceramics. In some alternative embodiments, a single crystal such as a quartz crystal may also be possible.

As an alternative embodiment, as shown in FIG. 2 to FIG. 4, a positioning groove 14 is provided on the supporting part 11. The positioning groove 14 is an annular groove arranged around the outer wall surface of the connecting part 12. A positioning block 24 is provided on the support 20. The positioning block 24 is disposed at one end of the support 20 close to the supporting part 11. The positioning block 24 has a disc-like structure arranged around the support 20. The positioning block 24 is shaped to match the positioning groove 14. When the support 20 is sheathed on the connecting part 12 and connected to the supporting part 11, the positioning block 24 is inserted into the positioning groove 14 to engage with the positioning groove 14 each other. At this time, the side wall surface of the positioning block 24 abuts against and is fixedly connected the side wall surface of the positioning groove 14 to dispose the support 20 to be coaxial with the connecting part 12. Thereby, it is possible to ensure that the inner annular surface 21 of the support 20 does not come into contact with the outer wall surface of the connecting part 12 when the support 20 is sheathed on the connecting part 12, and further to ensure the piezoelectric element 30 is not affected when the connecting member such as the bolt is fitted into the mounting hole 13. For ease of processing, the support 20, the support flange 23, and the positioning block 24 are integral.

It is to be understood that the positioning of the support 20 is not limited to the above configuration. In some alternative embodiments, a positioning block may be provided on the supporting part 11, and a positioning groove may be provided on the support 20. The positioning groove on the support 20 and the positioning block on the supporting part 11 may be shaped to be matched with each other and fixedly connected to each other when the support 20 is sheathed on the connecting part 12 and connected to the supporting part 11. In such case, the positioning requirement for the support 20 can also be satisfied, so that the support 20 and the connecting part 12 can be arranged to be coaxial, thereby ensuring that the inner annular surface 21 of the support 20 does not come into contact with the outer wall surface of the connecting part 12.

When the connecting member is fitted into the mounting hole 13 of the connecting part 12 in use of the charge output element 1 according to the embodiment of the disclosure, since the piezoelectric element 30 is connected to the support 20 in a sheathed manner and the support 20 is sheathed on the connecting part 12 and arranged with a clearance away from the connecting part 12, even if a stress is caused to be generated on the base 10 due to the fitting of the connecting member into the mounting hole 13, the stress will not be transmitted to the piezoelectric element 30 due to the clearance between the support 20 and the connecting part 12, and thereby preventing the impacts of the connecting member on the piezoelectric element 30. Further, the provision of the support flange 23 on the support 20 facilitates the positioning and bonding of the piezoelectric element 30, and enables the mass block 40 to be suspended above the support part 12. Furthermore, since the positioning block 24 and the positioning groove 14 which are matched with each other are correspondingly and respectively on the support 20 and the supporting part 11, it is possible to ensure that the support 20 and the connecting part 12 are coaxially arranged, and further to ensure the requirement for the clearance being left between the support 20 and the connecting part 12.

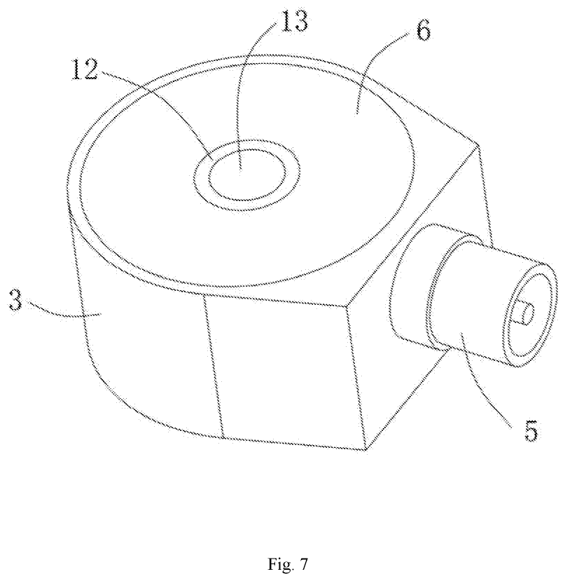

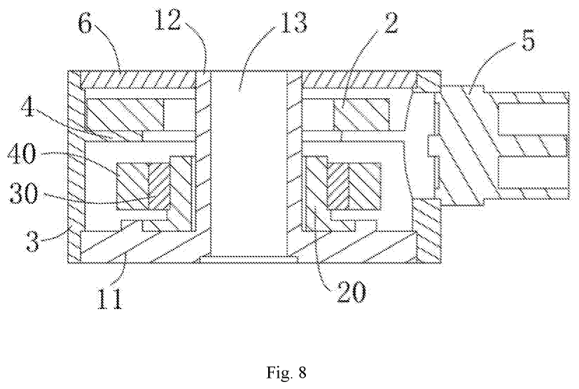

As shown in FIG. 7 and FIG. 8, another embodiment of the disclosure further provides an annular shear-type piezoelectric accelerometer, including the charge output element 1 according to any of the above embodiments, a circuit board 2, and a casing 3 arranged on an outer circumference of the charge output element 1 to surround the charge output element 1. A notch is provided along the circumferential direction below the inner wall of the casing 3, and the notch is engaged with the supporting part 11 of the base 10 in a snap-fit manner. A sealing cover 6 is provided at the top of the casing 3 to engage with the casing in a snap-fit manner. A through hole through which the connecting part 12 passes is provided in a central portion of the sealing cover 6. A top surface of the connecting part 12 is flush with a top surface of the sealing cover 6. The charge output element 1 and the circuit board 2 are both arranged within the casing 3. A connecting member 5 is arranged on the casing 3, and the piezoelectric element 30 and the connecting member 5 are electrically connected to the circuit board 2. A partition plate 4 is provided at a predetermined distance above the piezoelectric element 30 and the mass block 40. The partition plate 4 is an annular plate continuously arranged along the circumferential direction of the casing 3. The partition plate 4 is horizontally arranged and fixed to the inner wall surface of the casing 3. The circuit board 2 is a printed circuit board, and the circuit board 2 is arranged around the connecting part 12. The circuit board is located on one side of the partition plate 4, and the piezoelectric element 30 and the mass block 40 are located on the other side of the partition plate 4, so that the circuit board 2 is arranged at the predetermined distance from the piezoelectric element 30 and the mass block 40 and does not come into contact with the piezoelectric element 30 and the mass block 40, thereby preventing the impacts of the unevenness of the weight of the circuit board 2 on the mass 40 and the piezoelectric element 30, and further ensuring the stability of the frequency response and the transverse sensitivity of the annular shear-type piezoelectric accelerometer.

It is to be understood that the partition plate 4 is not limited to an annular plate that is continuously arranged along the circumferential direction of the casing 3 and horizontally arranged and fixed to the inner wall surface of the casing 3. In some alternative embodiments, the partition plate 4 may also be an annular plate that is continuously arranged along the circumferential direction of the connecting part 12, and the partition plate 4 may also be horizontally arranged and fixed to the outer wall surface of the connecting part 12.

Furthermore, the partition plate 4 is not limited to being arranged only on the inner wall surface of the casing 3 or only on the outer wall surface of the connecting part 12. In some embodiments, the partition plate 4 may be simultaneously and respectively provided on the inner wall surface of the casing 3 and the outer wall surface of the connecting part 12, and one portion of the partition plate 4 disposed on the inner wall surface of the casing 3 is placed on the same plane as the other portion of the partition plate 4 disposed on the outer wall surface of the connecting part 12, so as to better achieve the support of the circuit board 2.

Moreover, the structure of the partition plate 4 is not limited to the annular plate that is continuously arranged along the circumferential direction of the casing 3 and/or the connecting part 12. In some alternative embodiments, the partition plate 4 may also be two or more arc-shaped plates spaced apart in the circumferential direction of the casing 3, preferably two or more arc-shaped plates evenly distributed on the inner wall surface of the casing 3, so as to support the circuit board 2. Alternatively, the partition plate 4 may also be two or more arc-shaped plates spaced apart in the circumferential direction of the connecting part 12, preferably two or more arc-shaped plates evenly distributed on the inner wall surface of the connecting part 12. Alternatively, the inner wall surface of the casing 3 and the outer wall surface of the connecting part 12 may also be respectively provided with two or more arc-shaped plates that are spaced apart, and the arc-shaped plates on the inner wall surface of the casing 3 is placed on the same plane as the arc-shaped plates on the outer wall surface of the connecting part 12. By means of the structure and the mounting form of the partition plate 4 according to any of the above embodiments, it is possible to satisfy the support function of the circuit board 2, to ensure that the partition plate 4 does not come into contact with the piezoelectric element 30 and the mass block 40, and to prevent the impacts of the unevenness of the weight of the circuit board 2 to the piezoelectric element 30 and the mass block 40.

It is to be understood that the circuit board 2 is not limited to the printed circuit board. In some alternative embodiments, the circuit board 2 may also be a thick-film circuit board, which has small size and light weight. Furthermore, the circuit board 2 is not limited to being arranged around the connecting part 12 and supported on the partition plate 4. In some embodiments, when there is a sufficiently large space, the circuit board 2 may be arranged at any position as long as the circuit board 2 can be arranged at the predetermined distance from the mass block 40 and the piezoelectric element 30 so as not to contact the mass block 40 and the piezoelectric element 30.

The annular shear-type piezoelectric accelerometer according to the embodiment of the disclosure including the charge output element 1 according to any of the above embodiments, has the same advantages as the charge output element 1, so the same parts are not described herein. Further, the annular shear-type piezoelectric accelerometer further includes the circuit board 2, and the piezoelectric element 30 is electrically connected to the circuit board 2 to transmit an electrical signal of the piezoelectric element 30 to the circuit board 2. The electrical signal here is usually a charge signal or a voltage signal. The circuit board 2 is capable of amplifying an extremely weak charge (or voltage) generated after the piezoelectric element 30 is stressed to meet the use requirements. Furthermore, the circuit board 2 is arranged at the predetermined distance from the mass block 40 and the piezoelectric element 30 so as not to contact the piezoelectric element 30 and the mass block 40, thereby preventing the impacts of the unevenness of the weight of the circuit board 2 to the mass block 40 and the piezoelectric element 30, and thereby further ensuring the frequency response and the stability of the transverse sensitivity of the annular shear-type piezoelectric accelerometer.

Although the disclosure has been described with reference to the preferred embodiments, various modifications may be made thereto and the components may be replaced with equivalents without departing from the scope of the application. In particular, the technical features mentioned in the various embodiments can be combined in any manner as long as there is no structural conflict. The disclosure is not limited to the specific embodiments disclosed herein, but includes all technical solutions falling within the scope of the claims.

1. A charge output element, comprising:
a base, comprising a supporting part and a connecting part arranged on the supporting part, the connecting part being provided with a mounting hole;
a support, sheathed on the connecting part and arranged with a clearance away from the connecting part, the support being connected to the supporting part;
a piezoelectric element, connected to the support in a sheathed manner; and
a mass block, connected to the piezoelectric element in a sheathed manner and suspended above the supporting part.

2. The charge output element according to claim 1, wherein the support is an annular structural body arranged around the connecting part and comprises opposite inner and outer annular surfaces, the inner annular surface of the support is arranged with a clearance away from the connecting part, and the piezoelectric element is connected to the outer annular surface of the support in a sheathed manner.

3. The charge output element according to claim 2, wherein the outer annular surface of the support is provided with a support flange along a circumferential direction thereof, the support flange has a height higher than a height of the supporting part, and the piezoelectric element abuts against the support flange.

4. The charge output element according to claim 1, wherein one of the supporting part and the support is provided with a positioning groove, the other of the supporting part and the support is provided with a positioning block, and the positioning block and the positioning groove engage with each other when the support is connected to the supporting part to cause the support to be coaxial with the connecting part.

5. The charge output element according to claim 1, wherein the connecting part has a columnar structure, the mounting hole is arranged along an axial direction of the connecting part and penetrates the connecting part; and the supporting part has a disc-like structure arranged around the connecting part and is located at one end of the connecting part.

6. The charge output element according to claim 1, wherein the piezoelectric element is an annular structural body made of a piezoelectric ceramic or a quartz crystal and comprises opposite inner and outer annular surfaces, each of the inner annular surface and the outer annular surface of the piezoelectric element are plated with a conductive layer, and the mass block is connected to the outer annular surface of the piezoelectric element in a sheathed manner.

7. An annular shear-type piezoelectric accelerometer, comprising:
a charge output element comprising:
a base, comprising a supporting part and a connecting part arranged on the supporting part, the connecting part being provided with a mounting hole;
a support, sheathed on the connecting part and arranged with a clearance away from the connecting part, the support being connected to the supporting part;
a piezoelectric element, connected to the support in a sheathed manner; and
a mass block, connected to the piezoelectric element in a sheathed manner and suspended above the supporting part; and
a circuit board, arranged at a predetermined distance from the piezoelectric element and the mass block, the piezoelectric element being electrically connected to the circuit board to transmit an electrical signal of the piezoelectric element to the circuit board.

8. The annular shear-type piezoelectric accelerometer according to claim 7, further comprising a casing arranged around the charge output element, wherein a partition plate is provided on the casing and/or the connecting part, and the circuit board is arranged around the connecting part and supported on the partition plate.

9. The annular shear-type piezoelectric accelerometer according to claim 8, wherein the partition plate is an annular plate continuously arranged along a circumferential direction of the casing and/or the connecting part; or the partition plate comprises two or more arc-shaped plates spaced apart along the circumferential direction of the casing and/or the connecting part.

10. The annular shear-type piezoelectric accelerometer according to claim 8, further comprising a connecting member arranged on the casing and electrically connected to the circuit board.

11. The charge output element according to claim 2, wherein one of the supporting part and the support is provided with a positioning groove, the other of the supporting part and the support is provided with a positioning block, and the positioning block and the positioning groove engage with each other when the support is connected to the supporting part to cause the support to be coaxial with the connecting part.

12. The charge output element according to claim 3, wherein one of the supporting part and the support is provided with a positioning groove, the other of the supporting part and the support is provided with a positioning block, and the positioning block and the positioning groove engage with each other when the support is connected to the supporting part to cause the support to be coaxial with the connecting part.

13. The annular shear-type piezoelectric accelerometer according to claim 7, wherein the support is an annular structural body arranged around the connecting part and comprises opposite inner and outer annular surfaces, the inner annular surface of the support is arranged with a clearance away from the connecting part, and the piezoelectric element is connected to the outer annular surface of the support in a sheathed manner.

14. The annular shear-type piezoelectric accelerometer according to claim 13, wherein the outer annular surface of the support is provided with a support flange along a circumferential direction thereof, the support flange has a height higher than a height of the supporting part, and the piezoelectric element abuts against the support flange.

15. The annular shear-type piezoelectric accelerometer according to claim 7, wherein one of the supporting part and the support is provided with a positioning groove, the other of the supporting part and the support is provided with a positioning block, and the positioning block and the positioning groove engage with each other when the support is connected to the supporting part to cause the support to be coaxial with the connecting part.

16. The annular shear-type piezoelectric accelerometer according to claim 7, wherein the connecting part has a columnar structure, the mounting hole is arranged along an axial direction of the connecting part and penetrates the connecting part; and the supporting part has a disc-like structure arranged around the connecting part and is located at one end of the connecting part.

17. The annular shear-type piezoelectric accelerometer according to claim 7, wherein the piezoelectric element is an annular structural body made of a piezoelectric ceramic or a quartz crystal and comprises opposite inner and outer annular surfaces, each of the inner annular surface and the outer annular surface of the piezoelectric element are plated with a conductive layer, and the mass block is connected to the outer annular surface of the piezoelectric element in a sheathed manner.
